(19) United States
(12) Patent Application Publication
(10) Pub. No.: US 2021/0388995 A1
(43) Pub. Date: Dec. 16, 2021

(54) SYSTEMS AND METHODS FOR COOKWARE HAVING HEAT CONDUCTIVE ELEMENTS, AND AN OVEN UTILIZING THE COOKWARE

(71) Applicant: OVENTION, INC., MILWAUKEE, WI (US)

(72) Inventors: Tom Dulak, Luxemburg, WI (US); Ryan David Julius, New Franken, WI (US); Nathan Joseph Manders, Green Bay, WI (US)

(21) Appl. No.: 17/304,002

(22) Filed: Jun. 11, 2021

Related U.S. Application Data
(60) Provisional application No. 63/037,933, filed on Jun. 11, 2020.

(51) Int. Cl. F24C 15/32; A47J 36/02; A47J 36/34; F24C 15/16

(52) U.S. Cl. CPC F24C 15/322; F24C 15/166; A47J 36/34; A47J 36/027

(57) ABSTRACT

A cookware for use in an oven includes a heat maintaining body defining a cook surface, a plurality of heat conductive elements including a plurality of fins that extend from the heat maintaining body in a direction away from the cook surface, and can have a plurality of legs coupled to the fins. The legs can extend away from the heat maintaining body in a direction opposite the cook surface. The heat conductive elements are configured to conduct heat from a convective air flow to the heat maintaining body.

### CROSS-REFERENCES TO RELATED APPLICATIONS

This application claims the benefit and priority of U.S. Provisional Application No. 63/037,933, filed on Jun. 11, 2020, which is incorporated herein by reference in its entirety.

### STATEMENT REGARDING FEDERALLY SPONSORED RESEARCH

Not Applicable

### BACKGROUND OF THE TECHNOLOGY

The subject matter disclosed within relates generally to oven cookware, and more particularly to systems and methods for cookware having heat conductive elements, and an oven utilizing the cookware.

For most ovens, food, or anything to be heated, is placed on a cookware, see FIG. 1 for example. The cookware is placed within the oven chamber and heated, for example by exposure to heated air or other forms of heat. In a typical situation, the food, such as a pizza, would be grilled on the heated surface of the cookware similar to heating on the surface of a griddle or frying pan. However, the amount of heat energy retained by portions of known cookware is insufficient to provide a conducted heat flux into the food that is both consistent along an entire bottom surface of the food, and constant throughout the entire cook duration. In particular, the heat energy contained within the hot thermal mass of the known cookware is rapidly depleted by the food during the initial contact and throughout the remainder of the cook. Further, for consecutive cooks, insufficient additional heat energy is supplied to portions of the cookware in contact with the food, such that the cookware is unable to maintain a consistent and constant conducted heat flux, which results in a degradation in cook time (i.e., the food items required longer cook times to reach proper temperature), and browning over consecutive cooks.

Typically, if the food and cookware is being cooked in a convection oven, the convected heat flux delivered to the cookware by the heated airflow may be insufficient to maintain the temperature of the cookware, which can cause some portions of the food (such as the bottom outer perimeter) to be cooked faster than the center sections of the food surfaces, thereby resulting in unevenly toasted or browned food. This problem can be exacerbated over consecutive cooks, where cold food loads can repeatedly and rapidly deplete the heat energy stored in the cookware such that the cookware is unable to recover the lost heat energy between consecutive cooks. Therefore, in known oven cookware the amount of heat energy contained within the cookware and the convected heat flux into the cookware is limited and insufficient for an even browning on single or consecutive cooks.

What is needed is a cookware that is capable of distributing a substantially constant and even distribution of heat energy to the food item, which results in controlled browning on the food item for single or consecutive cooks.

### BRIEF SUMMARY OF THE TECHNOLOGY

The above problems can be solved by providing a cookware comprising a plurality of heat conductive elements, which may be shaped and positioned to deliver a consistent and stable heat flux to a bottom of a food item that may be placed on a top surface of the cookware.

In some embodiments, an oven can include a housing, a heating chamber positioned within the housing, a heat source to provide convective heated air to the heating chamber, and a cookware within the heating chamber. The cookware can include a heat maintaining body defining a cook surface and a plurality of heat conductive elements that can extend from the heat maintaining body in a direction away from the cook surface. The heat conductive elements can be configured to conduct heat from the heated air to the heat maintaining body as the heated air flows past the heat conductive elements. Additionally, the cook surface can be heated directly from above by the convective heated air entering the heating chamber and/or indirectly from below by the heat conductive elements conducting heat from the convective heated air to the cook surface.

In some embodiments, the plurality of heat conductive elements can be a plurality of fins extending in a direction of an airflow path of the convective heated air. Alternatively or additionally, the plurality of heat conductive elements can be a plurality of fins tangent, angled, or perpendicular to a direction of an airflow path to create directionality or turbulence in the convective heated air.

In some embodiments, the cook surface of the heat maintaining body can include an integrated thermal generative device that can be mounted any of internally, below, or under a bottom cavity of the oven or cookware. The thermal generative device can include at least one of a calrod heating element, a ribbon heating element, a mica heating element, and a silicone heating element. Alternatively or additionally, the cookware can include a removable cookware body that can have a power connection that can engage with a respective oven power connection when the cookware is inserted into the oven.

In some embodiments, the cookware may include a plurality of legs that may have a fixed or variable height to lift the cookware off of the bottom of the heating chamber. Each leg can include at least one foot to electrically insulate the cookware from the heating chamber.

In some embodiments, the cookware can be configured to be removable from the heating chamber of the oven, or the cookware can be configured to be fixedly mounted within the heating chamber of the oven.

In some embodiments, the heat conductive elements can be arranged so that the cookware can have a first cook profile when placed in the oven in a first orientation and can have second cook profile when placed in the oven in a second orientation.

In some embodiments, the oven may include at least a second cookware positioned above the first cookware. The second cookware may be inverted so that the cook surface of the first cookware faces a cook surface of the second cookware.

In some embodiments, a cookware can include a heat maintaining body defining a cook surface, a plurality of heat conductive elements including a plurality of fins that extend from the heat maintaining body in a direction away from the cook surface, and a plurality of legs coupled to the fins. The legs can extend away from the heat maintaining body in a direction opposite the cook surface. The heat conductive elements can be configured to conduct heat from a convective air flow to the heat maintaining body.

In some embodiments, at least a portion of the plurality of fins can be oriented in a direction of the convective air flow. At least a portion of the plurality of fins can be oriented tangent, angled, or perpendicular a direction of an airflow path to create directionality or turbulence in the convective air flow. At least a portion of the plurality of fins can have surface deformations, which can include at least one of recesses, bumps, ridges and sub-fins, to create additional surface area, directionality, or turbulence in the convective air flow. Additionally, the plurality of fins can include any of rectangular, square, and rounded fins that are disposed in an offset or staggered relationship and plurality of fins can create a weaved or waved airflow path that increases turbulence in the convective air flow. Furthermore, in some embodiments, the cookware can define an interior channel and the plurality of fins can disposed within the interior channel.

In some embodiments, the plurality of heat conductive elements can be made of a first material and the heat maintaining body can be made of a second material. Additionally, the plurality of heat conductive elements can include a plurality of turbulence generators that can increase turbulence in the convective air flow. The turbulence generators can include at least one of a plurality of rods and a plurality of air scoops. In some embodiments, the plurality of heat conductive elements can be permanently or removably coupled to the heat maintaining body of the cookware.

In some embodiments, the cook surface of the heat maintaining body can include an integrated thermally conductive feature to increase heat dispersion. The thermally conductive feature can include at least one of a heat pipe and a heat plate.

In some embodiments, the plurality of legs can be disposed between two or more of the plurality of fins. Alternatively or additionally, the plurality of legs can be connected on the outside of the plurality of fins. Furthermore, each of the plurality of legs can be formed from a non-conductive material.

In some embodiments, a method for heating food can include the steps of heating air via a heat source within a heating chamber of an oven, expelling the heated air into a cooking cavity of the oven toward a cook surface of a cookware, and directing at least a portion of the heated air to flow beneath the cookware and along a plurality of heat conductive elements extending from at least one of a bottom surface and an enclosed surface of the heat maintaining body. Heat from the heated air is conducted through the heat conductive elements to the heat maintaining body to heat the cook surface from the bottom of the heat maintaining body. The cook surface can be a top surface of a heat maintaining body and the heat conductive elements can extend in a direction away from the cook surface.

In some embodiments, the step of expelling the heated air into the cooking cavity can include blowing the heated air from an air plenum using a fan.

The oven can include a housing; a heating chamber positioned within the housing; a heat source to provide heated air to the heating chamber; at least one oven door to provide access to the heating chamber; and a cookware within the heating chamber, the cookware comprising a cook surface, a heat maintaining body, and a plurality of heat conductive features extending outwardly therefrom.

In some embodiments, the plurality of heat conductive features of the cookware is a plurality of fins.

In some embodiments, the plurality of fins absorb heat energy from the hot convected airflow that flows through the plurality of fins. This increased amount of heat energy flow is absorbed and retained in the thermal body for transfer to the cooking surface. The conducted heat energy maintains an even body and surface temperature throughout multiple cooks when frozen, chilled, room temperature, or hot food product is repeatedly placed and cooked upon the cook surface.

These and other benefits may become clearer upon making a thorough review and study of the following detailed description. Further, while the embodiments discussed above can be listed as individual embodiments, it is to be understood that the above embodiments, including all elements contained therein, can be combined in whole or in part.

### BRIEF DESCRIPTION OF DRAWINGS

The technology will be better understood and features, aspects and advantages other than those set forth above will become apparent when consideration is given to the following detailed description thereof. Such detailed description makes reference to the following drawings.

FIG. 1 is a perspective view of a prior art pizza stone;

FIG. 2 is a front perspective of an oven in section according to aspects of the disclosure;

FIG. 3 is a side view of an oven in section according aspects of the disclosure;

FIG. 4 is a top left perspective view of an example cookware according to aspects of the disclosure;

FIG. 5 is a bottom right perspective view of the cookware of FIG. 4;

FIG. 6 is a front perspective view of the cookware of FIG. 4;

FIG. 7 is a top right perspective view of the cookware of FIG. 4;

FIG. 8 is a front perspective view of an example cookware according to aspects of the disclosure;

FIG. 9 is a bottom view of an example cookware having a plurality of diagonal fins that each extend between two edges of the cookware, according to aspects of the disclosure;

FIG. 10 is a bottom view of an example cookware having a plurality of fins positioned in offset lines running from the front of the cookware to the rear of a the cookware, according to aspects of the disclosure;

FIG. 11 is a bottom view of an example cookware having a plurality of fins positioned in offset lines running diagonally along the bottom of the cookware such that the fins are mirrored about a centerline of the cookware, according to aspects of the disclosure;

FIG. 12 is a front view of a section of a cookware having a plurality of longitudinal fins with a plurality of ribs on the sides of the fins, according to aspects of the disclosure;

FIG. 13, is a bottom perspective view of a section of the cookware of FIG. 12;

FIG. 14 is a front perspective view of a cookware having an internal air cavity that includes a plurality of fins with sub-fins, according to aspects of the disclosure;

FIG. 15 is a front view of a cookware having a plurality of fins extending between a heat maintaining body and a bottom plate to form a plurality of air flow channels between the fins, according to aspects of the disclosure;

FIG. 16 is a front view of a cookware having a plurality of fins secured within slots formed a heat maintaining body, according to aspects of the disclosure;

FIG. 17 is a front perspective view of a cookware having a plurality of fins forming from a single sheet to form triangular channels within each of the fins, according to aspects of the disclosure;

FIG. 18 is a bottom perspective view of a cookware having a plurality of fins with a smoothed wavy profile, according to aspects of the disclosure;

FIG. 19 is a bottom perspective view of a cookware having a plurality of fins with a pointed wavy profile, according to aspects of the disclosure;

FIG. 20 is a bottom perspective view of a cookware having a plurality of fins and a plurality of tabs disposed between the fins, according to aspects of the disclosure;

FIG. 21 is a front perspective view of a cookware having a plurality of longitudinal fins extending from a heat maintaining body and a set of angled fins running perpendicularly to and attached to the longitudinal fins, according to aspects of the disclosure;

FIG. 22 is top front perspective view of a cookware having a plurality of heat pipes disposed along a top cook surface, according to aspects of the disclosure;

FIG. 23 is a top perspective view of a cookware having a heat maintaining body configured as a heat plate, according to aspects of the disclosure;

FIG. 24 is a top perspective view of a cookware having a heat dispersion element and three sets of fins, according to aspects of the disclosure;

FIG. 25 is a top perspective view of a cookware heating element configured as a ribbon heating element having a square shape according to aspects of the disclosure;

FIG. 26 is a top perspective view of a cookware heating element configured as a ribbon heating element having a circular shape according to aspects of the disclosure;

FIG. 27 is a top perspective view of a cookware heating element configured as a mica heating element having an annular shape according to aspects of the disclosure;

FIG. 28 is a rear perspective view of a removable heating element for use in an oven, according to aspects of the disclosure;

FIG. 29 is partial perspective view of a cooking cavity of an oven configured to power the removable heating element of FIG. 28;

FIG. 30 is a side view of an oven in section, and showing aspects of the airflow within the oven and the cookware with a plurality of fins, according to embodiments of the disclosure;

FIG. 31 is a front view of an oven in section, and showing aspects of the airflow within the oven and the cookware with a plurality of fins, according to embodiments of the disclosure;

FIG. 32 is a front view of another oven in section, and showing aspects of the airflow within the oven and the cookware with a plurality of fins, according to embodiments of the disclosure;

FIG. 33 a front view of another oven in section, and showing aspects of the airflow within the oven and the cookware with a plurality of fins, according to embodiments of the disclosure;

FIG. 34 a front view of another oven in section, and showing aspects of the airflow within the oven and the cookware with a plurality of fins, according to embodiments of the disclosure;

FIG. 35 is a front view of another oven in section showing a second cookware positioned above the first cookware, and showing aspects of the airflow within the oven, according to embodiments of the disclosure.

FIG. 36 is a bottom view of an oven in section, and showing aspects of the airflow within the oven and the cookware with a plurality of fins, according to embodiments of the disclosure; and

FIG. 37 is a method for heating food in an oven using a cookware, according to embodiments of the disclosure

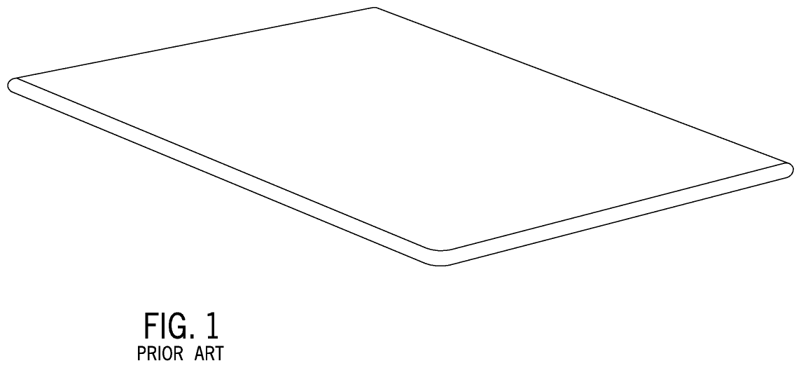

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION OF THE EMBODIMENTS

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the use the phraseology and terminology used herein is for the purpose of description and should not be regarded as limiting. Furthermore, the use of “right”, “left”, “front”, “back”, “upper”, “lower”, “above”, “below”, “top”, or “bottom” and variations thereof herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. As used herein, the singular forms “a”, “an”, and “the” include plural embodiments unless the context clearly dictates otherwise.

As used herein, unless otherwise specified or limited, “at least one of A, B, and C,” and the like, is meant to indicate A, or B, or C, or any combination of A, B, and/or C. As such, these and similar phrases can include single or multiple instances of A, B, and/or C, and, in the case that any of A, B, and/or C indicates a category of elements, single or multiple instances of any of the elements of the category (or categories).

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

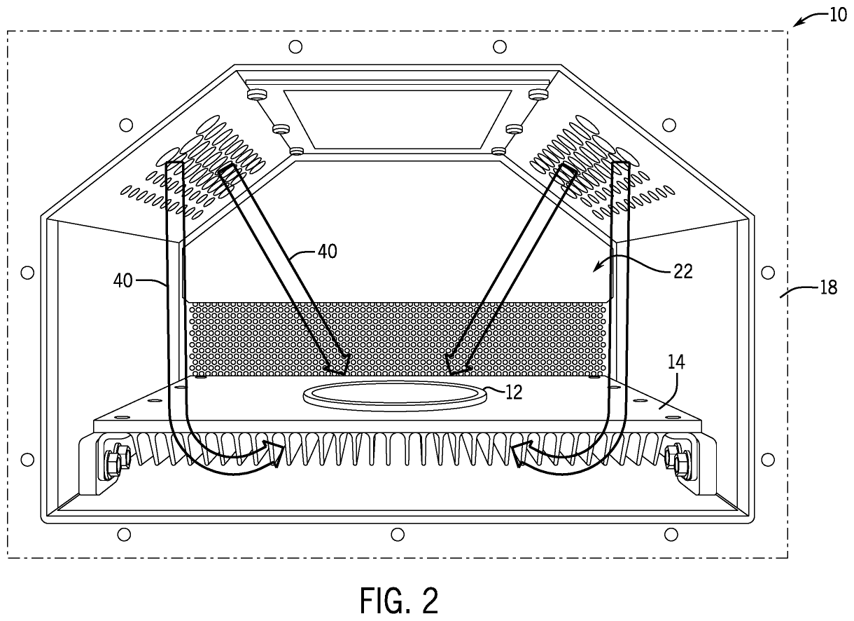

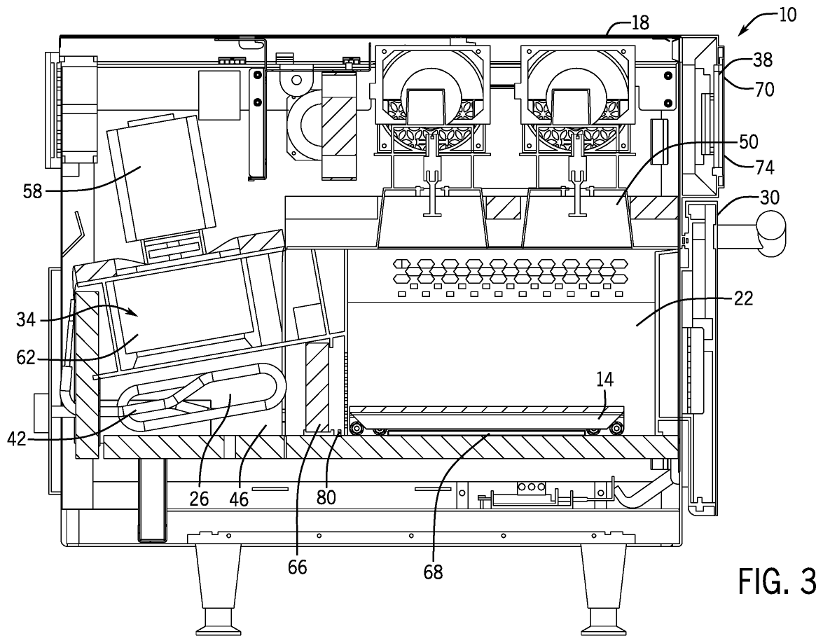

Referring now to FIGS. 2-3, there are depicted embodiments of an oven 10 with a cookware 14. The oven 10 can be defined by a housing 18 having a cooking cavity 22. The oven 10 may also include one or more heating chambers 26 disposed within the housing 18. In some embodiments, the one or more heating chambers 26 may be an upper heating chamber and a lower heating chamber. Additionally, the housing 18, as well as the cooking cavity 22, can have at least a first oven door 30 for access to the cooking cavity 22. It is to be appreciated that the concepts described herein can be incorporated within an oven having no oven doors or an oven having one or more oven doors. It is also to be appreciated that the concepts described herein can also be incorporated within an oven having one or more air curtains and/or one or more conveyors.

Systems and methods for an oven are disclosed. In general terms, the oven 10 can comprise at least two primary systems; a heating and airflow system 34, and a control system 38 to control the heating. Each of these systems 34, 38, will be described below.

The oven 10 of the embodiments can be any type of oven that is capable of generating a heated airflow 40 within the one or more heat chambers 26 of the oven 10. In some embodiments, the oven 10 can be a convected heated air oven, for example, forced convention, natural convection, or impingement configurations.

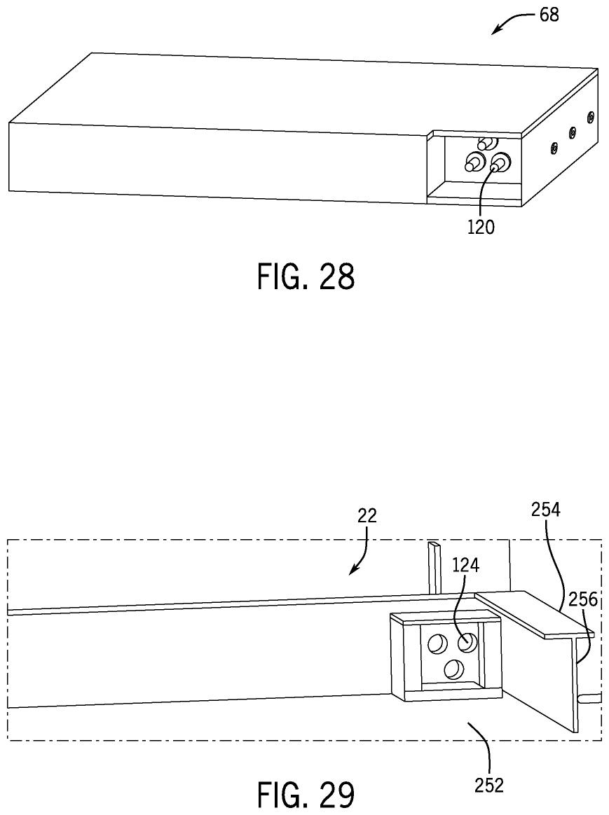

Furthermore, turning briefly to FIGS. 28-29, in other embodiments, additional thermal generative elements 68 (i.e., heating elements) may be disposed along the bottom 252 of the cooking cavity 22 of the oven 10 so that they may be positioned below the cookware 14. The thermal generative element may include an internal heating element or an external heating element. Such thermal generative elements 68 may be removable from the oven 10 and may include an electrical power connection 120 that is configured to electrically connect with a corresponding electrical power connection 124 provided in the cooking cavity 82. It is also contemplated that similar thermal generative elements may also be attached to the cookware 14 or they may be integral with the cookware 14.

For example, the cookware 14 may have an interior cavity 116 that may be configured retain a thermal heat generative element. In this way, the thermal heat generative element 68 can directly contribute heat energy to the cookware 14. Thus, heat energy may be added to the cookware 14 both by convection from the heated air flow via the heat conductive elements 90, and from the heat generative element 68.

Furthermore, it is contemplated that a heat generative element 68 included in or attached to the cookware 14 may also serve to provide a heated airflow 40 to the cooking cavity 22 of the oven 10. In particular, the heat generative element 68 may generate heat energy that is conducted to the air in the cooking cavity 22 via the heat conductive elements 90. It is also contemplated that a fan (e.g., a motor 58 operatively connected with a blower wheel 58) may be included so that the heated airflow 40 provided by the heat conductive elements 90 may be a forced convective airflow.

Turning back to FIGS. 2-3, in some embodiments, at least one cavity heating element 42 can heat air within one or more air plenums 46 of the one or more heating chambers 26. In some embodiments, a top air plenum and a bottom air plenum can be included. A motor 58, e.g., a brushless DC motor, a servo motor, a stepper motor, or any known motor, can spin a blower wheel 62, e.g., a backward incline blower wheel, or a fan, to draw air through the center of the blower wheel 62 and to expel the air out the perimeter of the blower wheel 62 into the air plenums 46. In some cases other known means for supplying an airflow may be used, for example, an air compressor to provide a high pressure airflow. In some embodiments, the air can pass through a catalyst 66, which may contain platinum, palladium, and/or rhodium. Additionally, or alternatively, the air can pass through one or more heat packs (not shown), for example, an upper heat pack and a lower heat pack, thereby completing a closed loop air path to provide convected heated air 40. Furthermore, it is to be appreciated that the air path does not need to be a closed loop air path, and that an open loop air path is also envisioned.

For additional heating, one or more optional heating elements, e.g., an infrared element 68, may be placed within the oven 10 or cooking cavity 22 for supplying heat energy towards any item located within the cooking cavity 22.

It is to be appreciated that other heating systems, such as microwave, steam, impingement, induction, or infrared radiation, or a combination thereof, can be used instead of or in combination with the heating element 42. It is also to be appreciated that the heated air 40 and any additional heating elements 68 or sources can be independently controlled.

The oven 10 can comprise a control system 38. In some embodiments, operating parameters for the oven 10 to cook any items placed within the cooking cavity 22 can be entered at a first user interface control panel 70. For example, operating parameters may include, but are not limited to, airflow control (i.e., top and/or bottom air flow), time, temperature, microwave percentage, and/or infrared percentage. Any combination of the operation parameters may be combined to create programs for cooking. The programs may include one or more cooking stages having different or similar operating parameters. Furthermore, to select a cooking program or a specific operating parameter, the user interface control panel may include a corresponding icon or button that can be selected by a user, and may also include a corresponding description to provide information to the user.

A user interface 74 can be implemented with a dial system, switches or button controls, a touch screen, or a keypad and liquid crystal display (LCD). An operator can enter commands, such as mode of operations, cooking temperatures within the cooking cavity 22, cooking time, blower speed, etc., via the user interface 74 to effectuate cooking controls on any items placed within the cooking cavity 22. The user interface 74 can be associated with a non-volatile memory for storing various cooking instructions, such as cook times, cook temperatures and blower speeds, for different items under the names or graphical representations of corresponding items.

At least one sensor 80, such as a thermocouple, can be positioned in various locations within the oven housing 18 to measure temperature and other environmental conditions, e.g., humidity, and provide the measured data to the control system 38.

Systems and methods of a cookware 14 are disclosed. In particular, the cookware 14 can be a removable cookware configured to be placed inside cooking cavity 22 of the oven 10 and is capable of causing even browning throughout a bottom, cookware-contacting surface of the food 12 prepared through use of the oven 10, such that the food 12 has the same or similar appearance as food prepared by conventional convection ovens with high velocity bottom airflow, hearth stone ovens, or grills (see FIG. 2). Alternatively, the cookware 14 may be configured as stationary cookware 14 that can be mounted within a cooking cavity, such as cooking cavity 22 of oven 10. When mounted within the oven 10, the cookware 14 may form a shelf within a cooking cavity 22 of the oven 10.

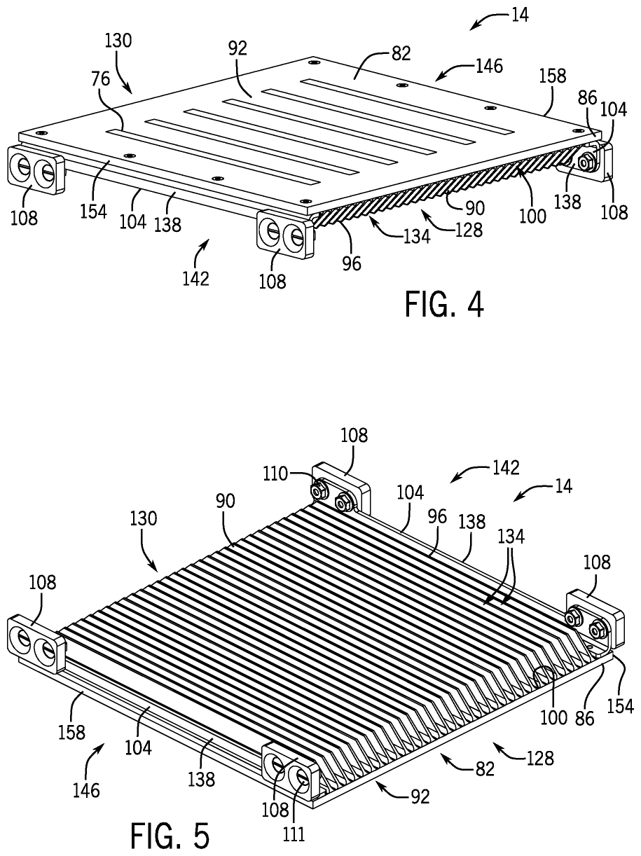

Referring to now to FIGS. 4-24, the cookware 14 can comprise a cook surface 82, a heat maintaining body 86, and a plurality of heat conductive elements 90 extending outwardly therefrom. In some embodiments, the cook surface 82 may be a top surface 92 of the heat maintaining body 86. Furthermore, the cook surface 82 may be flat or the cook surface 82 may include a number of grooves or other elements to help retain the item being cooked on the cook surface 82. For example, cookware may have a top surface configured to be flat for even browning or the top surface may include grilling ribs, holes, or other patterns 76, such as logos or decals to produce areas with differing degrees of browning.

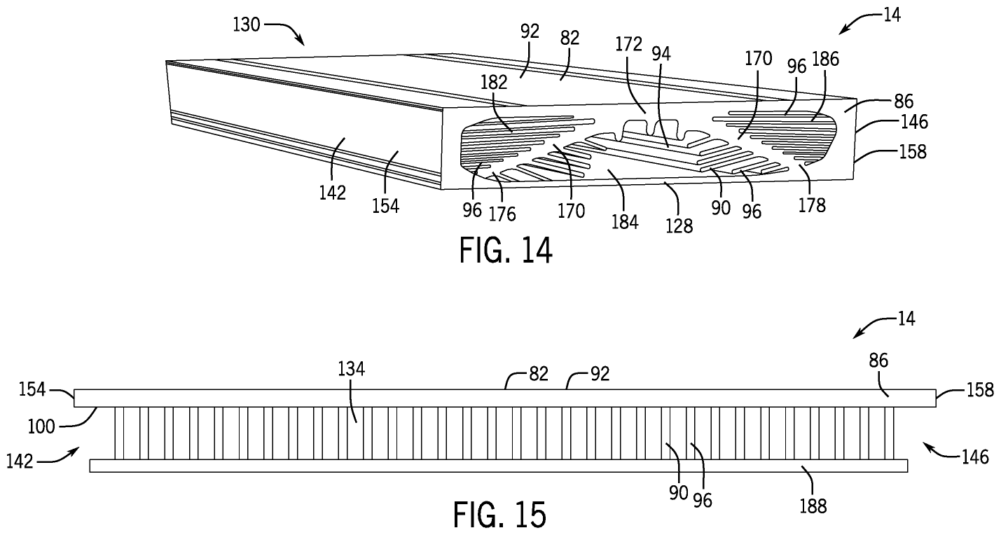

In other embodiments, the cookware 14 may define an interior channel 94 (see FIG. 14) extending through the heat maintaining body 86 and the heat conductive elements 90 may extend from or between one or more internal surfaces of the internal flow path.

The heat conductive elements 90 can be in any shape or form that is suitable to direct or allow heat energy to flow towards the cook surface 82 and the heat maintaining body 86 of the cookware 14. For example, in some embodiments, the heat conductive elements 90 may be a plurality of longitudinal fins 96 that extend along the flow path 98 of the heated air 40. The fins 96 may be any of rectangular, square, and rounded fins and may be disposed in an offset or staggered relationship. Furthermore, the fins 96 may extend downwardly from a bottom surface 100 of the heat maintaining body 86, opposite the cook surface 82. The fins 96 may extend substantially perpendicularly to the bottom surface 100 of the heat maintaining body 86, however, this need not be the case and the fins 96 may also extend at an angle to the bottom surface 100 of the heat maintaining body 86. It should be appreciated that, in other embodiments, other shapes are envisioned, such as chevron, convex, concave, conical, cubed, depressions, fluted, helical, spherical, triangular, rod shaped, or combinations thereof, as non-limiting examples. Furthermore, the heat conductive elements 90 may only extend across a portion of the heat maintaining body 86 and/or the heat conductive elements 90 may be offset from each other to create a weaving or oscillating flow path for the heated air 40. Additionally, is it contemplated the heat conductive elements 90 may include bumps, ridges, recesses, other deformations, additional sub-fins, or other elements on the exterior of the heat conductive elements 90 for triggering turbulent air flow and/or increasing heat transfer between the heated air 40 and the heat conductive elements 90 by providing an increased surface area.

The heat conductive elements 90 can be arranged to substantially distribute heat energy throughout one or more surfaces of the cookware 14. In some embodiments, the plurality of heat conductive elements 90, e.g., fins 96, may extend from one edge of the cookware 14 to another edge of the cookware 14. In some embodiments, the plurality of heat conductive elements 90 can be spaced out evenly or unevenly along a width of the cookware 14. In some embodiments, the plurality of heat conductive elements 90 can be arranged in a circular or serpentine or triangular pattern, or combinations thereof, as non-limiting examples. In one non-limiting example, there may be less heat conductive elements 90 around the edges of the cookware 14 and more heat conductive elements 90 in the center of the cookware 14 to focus and direct the heat energy from the heated air 40 to the center of the cook surface 82. In some embodiments, the heat conductive elements 90 can have different heights. For example, the heat conductive elements 90 may be shorter around the edges and taller near the center of the cookware 14 to focus and direct the heat energy to the center of the cook surface 82. In some embodiments, a specific arrangement of fins 96 or other heat conductive elements 90 could allow the cookware 14 to have one cook profile when placed in the oven 10 in one orientation, and a different cook profile when the cookware 14 is placed in the oven 10 in a different orientation, e.g., rotated horizontally 90 degrees. For example, the cookware 14 could be placed in the oven 10 in a first orientation that may be optimized to cook a food product of a specific size and/or shape (e.g., a 10 inch round product). Alternatively, the cookware 14 could be placed in the oven 10 in a second orientation that may be rotated any of 90, 180, or 270 degrees, as non-limiting examples, from the first orientation, which may be optimized to cook a food product having a different size and/or shape. (e.g., a 9 inch or 12 inch round or rectangular product). It should be appreciated that optimizing the cooking of the aforementioned food products may vary depending on the desired end state of the food. For example, one orientation may be optimized to provide greater heat flow to the center of the cookware 14 than another orientation, or one orientation may provide greater browning than another orientation.

The cookware 14 can be made of thermally conductive materials including, but not limited to, metal, ceramic, clay, stone, glass, graphite, thermal foam pads, or thermal compounds, liquid/vapor chamber heat pipes, or combinations thereof. In some embodiments, the cook surface 82, the heat maintaining body 86, and the plurality of heat conductive elements 90 can be made of the same material, such as aluminum. In some embodiments, the cook surface 82, the heat maintaining body 86, and the plurality of heat conductive elements 90 can be made of more than one material. For example, the heat conductive elements 90 can be made of aluminum, while the cook surface 82 and heat maintaining body 86 can be made of a ceramic material.

Furthermore, in some embodiments, the cooking surface 82, heat maintaining body 86, and the heat conductive elements 90 may be formed as a single component, or, in other embodiments, as separate components that can be joined together. For example, cooking surface 82, heat maintaining body 86, and the heat conductive elements 90 may integrate with one another such that they can be formed from a single piece of aluminum. Conversely, the heat maintaining body 86 and the heat conductive elements 90 may be formed as separate components that can be configured to be joined together, for example, by fasteners or by welding, to form the cookware 14. For example, the heat conductive elements 90 may be separate fins 96 that can be inserted into slots in the heat maintaining body 86 or otherwise fastened to the heat maintaining body 86. Alternatively, the heat conductive elements 90 may be formed from a bent piece of sheet metal, for example, attached to the heat maintaining body 86 to form a plurality of hollow fins.

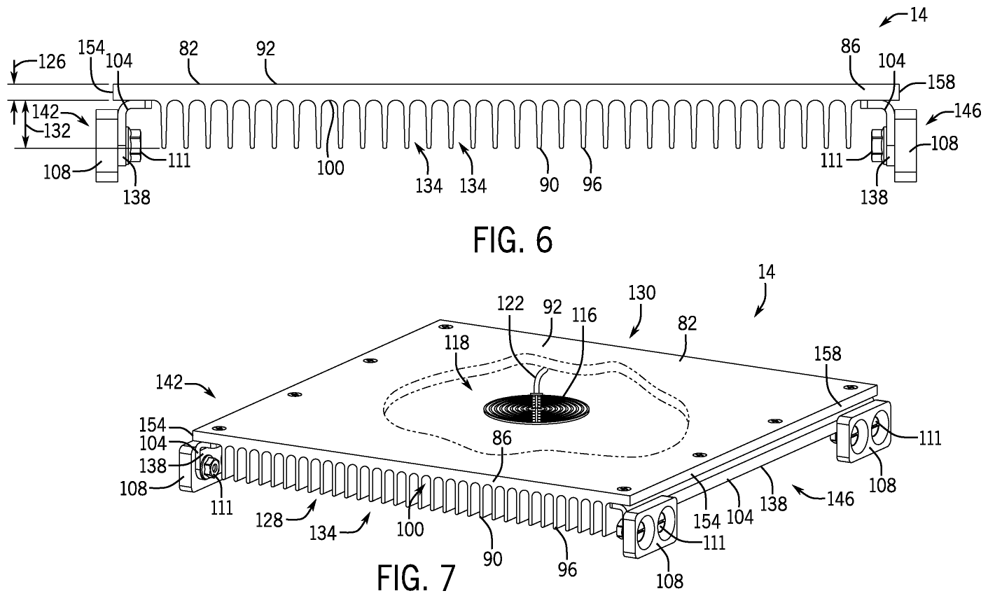

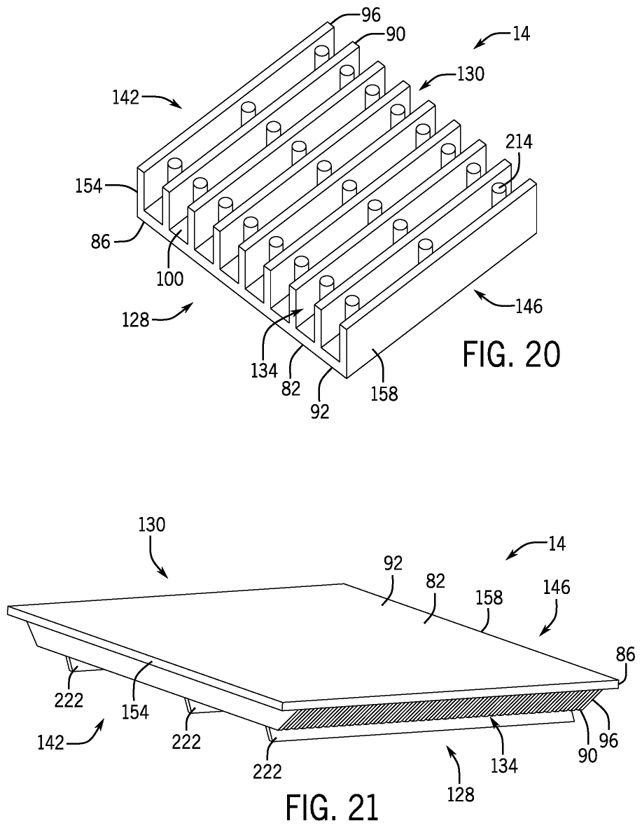

The cookware 14 can be in any exterior shape or form that is suitable to be placed into the cooking cavity 22 of the oven 10. In some embodiments, the exterior shape of the cookware 14 can be a square, a rectangle, or circular, as non-limiting examples. In some embodiments, the exterior shape of the cook surface 82 may be optimized based on the internal shape of the oven 10 to allow for maximum convective air flow, either forced or natural, and maximum absorption of heat energy by the heat conductive elements 90. In some embodiments, the cooking cavity 22 can include one or more obstacles 214 in the air flow path to provide a controlled turbulence of hot air to affect the air flow in contact with the heat conductive elements 90 (see FIG. 20). In some embodiments, the cookware 14 can have a ratio of height 126 of the heat conductive elements 90 to the thickness 132 of the heat maintaining body 86 between 0.1-1 and 10-1, or more or less (see FIG. 6).

In some embodiments, the cookware 14 may further comprise a plurality of legs 104. In some embodiments, the cookware may further comprise a plurality of feet 108 attached to each of the plurality of legs 104. The feet 108 may be integral with the legs 104, or the feet 108 may be separate components that are coupled with the legs 104, for example, by nuts 110 and bolts 111, or any other coupling means as known in the art. The plurality of legs 104 can be used to lift the cookware 14 off the bottom of the oven 10 and the height of the legs 104 can be varied to meet the requirements of a specific application to allow for a larger or smaller airflow path for the return airflow as it passes beneath the cookware 14. For example, in some embodiments the legs 104 may have a fixed height while in other embodiment the legs 104 may be configured to have an adjustable height. In some embodiments, the feet 108 and/or legs 104 can be made of electrically insulating material thereby electrically isolating the cookware 14 in the oven 10 from sides of the cooking cavity 22, e.g., in a microwave style oven. In other embodiments the cookware 14 may be mounted within the cavity of the oven 10, and as such, the cookware 14 may not include any legs.

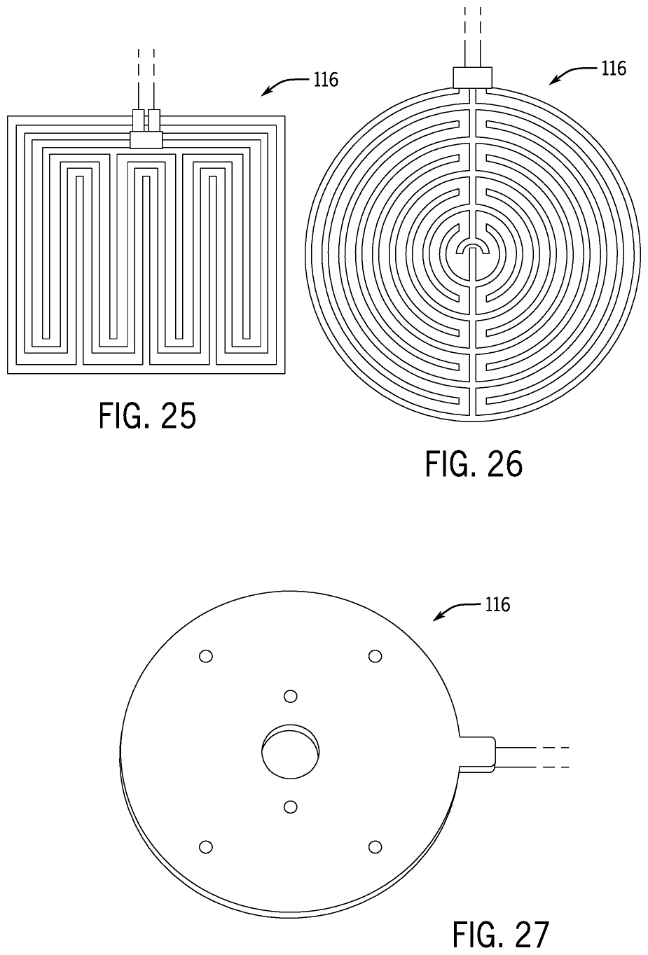

In some embodiments, the cookware 14 can further comprise a temperature sensor 112 and a heating mechanism 116, which may be in electronic communication with the control system 38 of the oven 10 such that an operator can control the cooking command of the oven thereby controlling the heat profile of the cooking surface 82. The heating mechanism 116 may be integrated with the heat maintaining body 86, for example by inserting the heating mechanism 116 into an interior cavity 118 defined within the heat maintaining body 86, and/or by attaching the heating mechanism 116 to a surface, such as the bottom surface 100 of the heat maintaining body 86. In some embodiments, the heating mechanism 116 may be one or more of calrod heating elements, ribbon heating elements, mica heating elements, silicone heating elements, or other heat generative components as known in the art (see FIGS. 25-27, showing a square ribbon heating element, a circular heating element, and an annular mica heating element, respectively). In other embodiments, the heating mechanism 116 may be of a type that can be removably or permanently integrated within the cookware 14 and may include a power connection 122 (see FIG. 7) that can be configured to electrically connect with mating power connection 124 provided within a cooking cavity 22 of an oven 10 (see FIG. 29).

With specific reference to FIGS. 4-6, an example cookware 14 is shown. The cookware 14 can include a square heat maintaining body 86 defining a top cooking surface 82 having a lined pattern 76 to create areas having different levels of browning (e.g. for creating grill lines) and a plurality of equally or unequally spaced longitudinal fins 96 extend perpendicularly downward from a bottom surface 100 of the heat maintaining body 86. The fins 96 can be integral with the heat maintaining body 86, and can have a rectangular cross section, and can extend from a front 128 of the cookware 14 to a rear 130 of the cookware 14, to define a plurality of open airflow channels 134. One or more of the fins 96 can be chamfered at the front 128 and/or rear 130 of the cookware 14. One or more legs 104 (two legs are shown) can be fastened proximate the remaining sides of the cookware 14, and each can include a bracket 138 fastened to the heat maintaining body 86 and two feet 108 fastened to each distal end of the bracket 138. The feet 108 may be made from a plastic or other non-conductive material. In some embodiments, the legs 104 can be disposed to the exterior of the fins 96. In other embodiments, the legs can be disposed in other areas to support the cookware 14. Other arrangements for legs and feet are possible to support the cookware 14.

With reference to FIG. 7, another example cookware 14 is shown. The cookware 14 is similar to the cookware of FIGS. 4-6, however, one or more of the fins 96 may not be chamfered proximate the front and/or rear ends of the cookware 14.

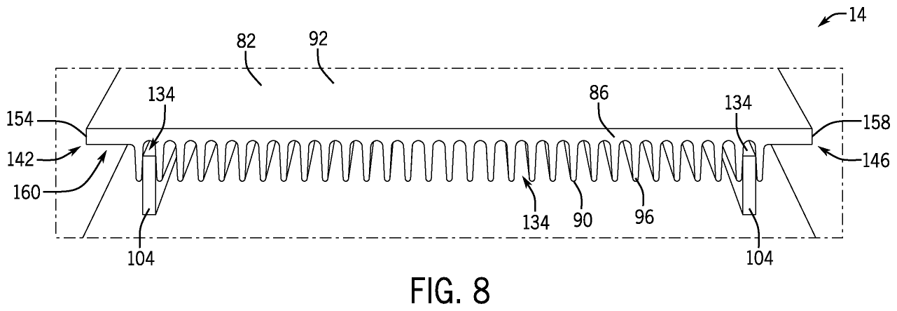

With reference to FIG. 8, another example cookware 14 is shown. The cookware 14 is similar to the cookware of FIG. 7, however, the legs 104 can be nested within air flow channels 134 on either side 142, 146 of the cookware 14. Furthermore, the cookware 14 shown in FIG. 7 may also include a heating mechanism 116 which is shown as being disposed within and internal cavity 118 of the heat maintaining body 86. By including the heating mechanism 116, additional heat energy can be added directly to the cookware 14 to improve temperature recovery when consecutive food loads are placed onto the cookware 14. It should be appreciated that a variety of known heating mechanisms 116 can be used, For example, the heating mechanism 116 may be one or more of calrod heating elements, ribbon heating elements, mica heating elements, silicone heating elements, or other heat generative components as known in the art (see FIGS. 25-27, showing a square ribbon heating element, a circular heating element, and an annular mica heating element, respectively). Furthermore, it should be appreciated that the heating mechanism 116 may include more than one heating mechanism and the heating mechanism 116 may be mounted in other locations on the cookware 14, for example, on the cooking surface 82.

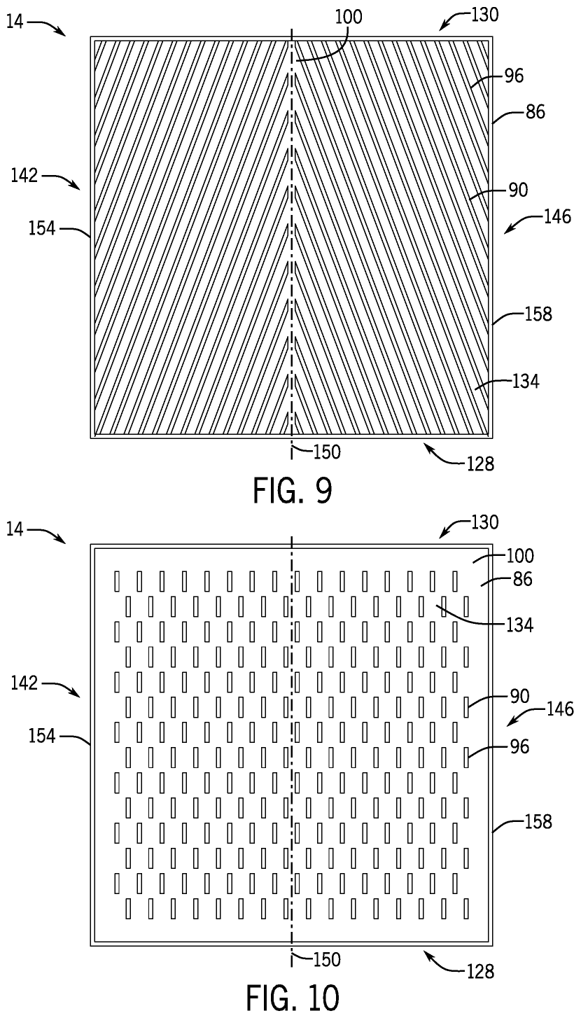

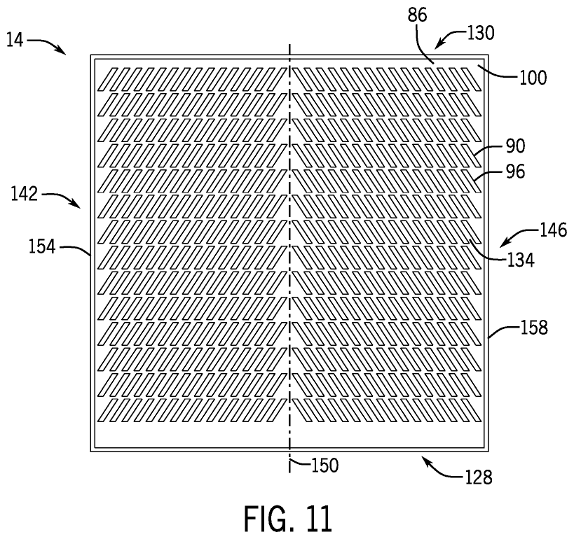

Turning to FIGS. 9-11, additional heat conducting fin arrangements are shown. With respect to FIG. 9, the fins 96 can be angled inwardly toward a midline 150 between the sides 142, 146 of the cookware 14, which can be oriented in the direction of the air flow. The fins can be equally or unequally spaced and mirrored about the midline 150, although not required. With respect to FIG. 10, each of a plurality of fins 96 may extend along a portion of a length of a cookware 14 from a front 128 to a rear 130 of the cookware 14. The fins 96 can be arranged in offset or staggered rows to form a checkerboard pattern, for example. The checkerboard pattern of the fins may cause the heated air 40 to have a weaving flow path that weaves around and between different rows. With respect to FIG. 11, a plurality of fins 96 can be arranged end to end to and may form multiple diagonal rows that can extend inward and rearward toward a midline 150 between the sides 154, 158, of the cookware 14. The rows can be equally or unequally spaced and mirrored about the midline 150. Although not required.

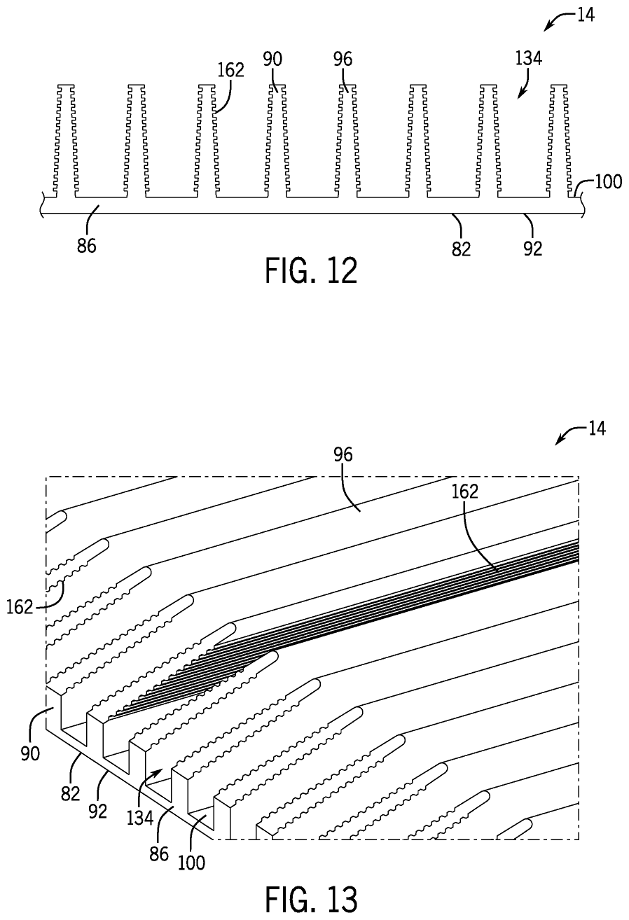

Turning to FIGS. 12 and 13, another example cookware 14 is shown. The cookware 14 is similar to the cookware shown in FIGS. 4 and 5, but can include a plurality of ribs 162 extending along a length of each fin 96. The ribs 162 can increase the surface area of each of the fins 96 to increase heat transfer from the heated air 40 to the fins 96. The ribs 162 can be on a chamfered edge as shown, and/or can be placed in one or more locations along the length of any of the fins for various applications.

Turning to FIG. 14, another example cookware 14 is shown. The cookware 14 can have a rectangular cross-section defining a top cooking surface 82 and a closed interior channel 94 extending through the cookware 14 from the front 128 of the cookware 14 to the rear 130 of the cookware. Two fin supports 170 may extend diagonally downward within the interior channel 94, extending from a first distal end 172 located proximate the middle and top of the interior channel 94 to a second distal end 176 located proximate the bottom left 178 and bottom right 180 corners of the interior channel 94, thereby forming three sub-channels 182, 184, and 186. A plurality of fins 96 can extend angularly from the sides of the fin supports 170 to aid in the transferring of heat from the heated air 40 flowing through the interior channel 94 to the heat maintaining body 86. In some cases, the fins 96 may extend so they connect with walls of the interior channel 94 and in other cases the distal ends of the fins 96 may not connect with walls of the interior channel 94. As shown, sub-channels 182 and 186 are approximately the same size, and are smaller than sub-channel 184. However, it should be appreciated that the size and number of sub-channels may vary depending on the size of the interior channel 94 and the number and arrangement of any fins 96 and their respective fin supports 170.

Turning to FIG. 15, another example cookware 14 is shown. The cookware 14 is similar to the cookware to shown in FIGS. 6 and 7, but does not include legs. Instead, the cookware 14 can include a base plate 188 attached to the distal ends of the fins 96, thereby forming a plurality of equally or unequally spaced rectangular airflow channels 134 between each of the fins 96. In this configuration, the base plate 188 can provide a large stable platform for the cookware 14 along its bottom surface 100. In addition, the inclusion of the base plate 188 can allow the cookware 14 to be flipped over so that the bottom surface 192 of the base plate 188 can also be used as a secondary cook surface. Further, because the base plate 188 and the heat maintaining body 86 may have different thicknesses, each of the base plate 188 and the heat maintaining body 86 may effectuate different levels of browning.

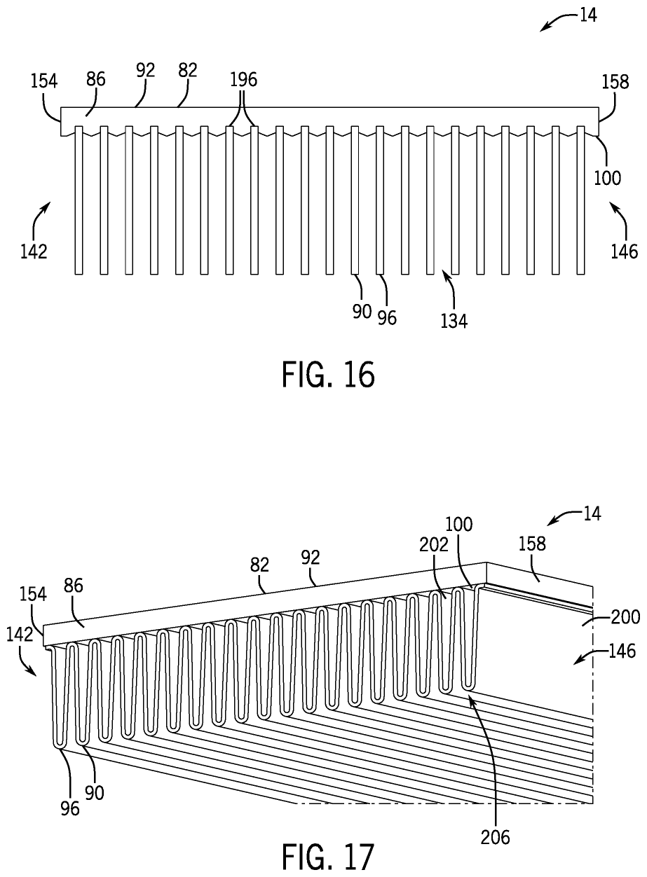

Turning to FIG. 16, another example cookware 14 is shown. The cookware 14 can include a heat maintaining body 86 defining a cooking surface 82 and a plurality of longitudinal slots 196 in a bottom surface 100 opposite the cooking surface 82. One or more of the slots 196 can be configured to receive one of a plurality of heat conductive fins 96. Here, the slots 196 are equally spaced, but this may differ in other embodiments.

Turning to FIG. 17, another example cookware 14 is shown. The cookware 14 can include a heat maintaining body 86 defining a cooking surface 82 and a bottom surface 100 opposite the cooking surface 82. The cookware 14 can also include an interconnected fin structure 200 that can be formed by repeatedly folding a heat conducting sheet of material, e.g., aluminum or other metals, into an accordion-like shape. The fin structure 200 can be attached at one side to the bottom surface 100 of the heat maintaining body 86. In this way, the fin structure 200 can form a plurality of closed, generally triangular channels 202, which share a side with the heat maintaining body 86, and a plurality of open, generally triangular channels 206 that open in a direction away from the heat maintaining body 86. In other embodiments, the fin structure 200 may be folded in other ways to create different channel profiles, for example, a square or rectangular profile.

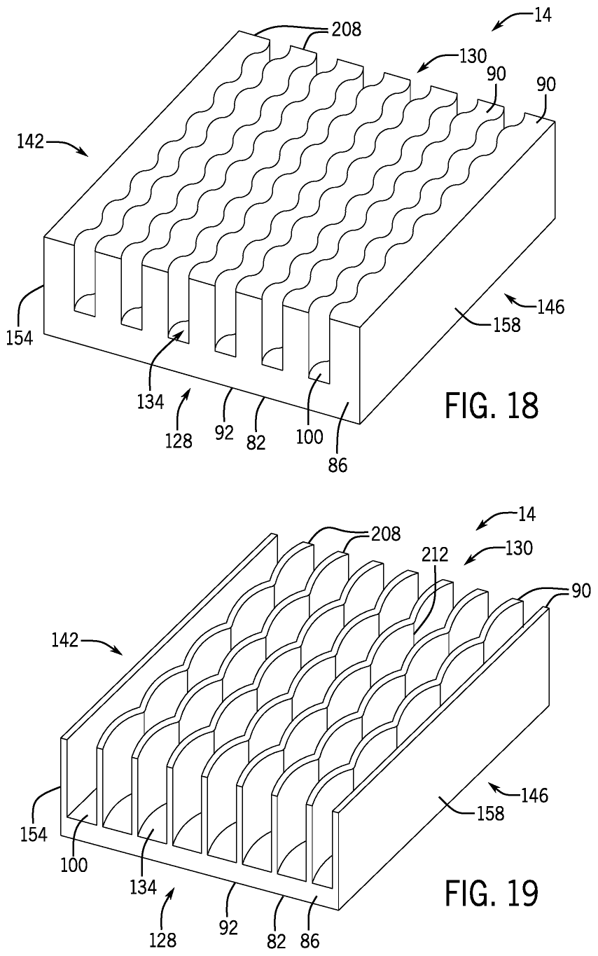

Turning to FIG. 18, another example cookware 14 is shown. The cookware 14 can include a heat maintaining body 86 defining a cooking surface 82 and a bottom surface 100 opposite the cooking surface 82. The cookware 14 can include a plurality of wavy fins 208 extending from the heat maintaining body 86, which define oscillating airflow channels 134 that can result in a wavy air flow of the heated air 40. The airflow channels 134 can be arranged to oscillate perpendicularly to the length of the airflow channel 134 going from a front 128 of the cookware 14 to a rear 130 of the cookware 14. The airflow channels 134 can be generally smooth with no sharp corners. In other embodiments, for example, as shown in FIG. 19, airflow channels 134 can include sharp corners 212 to better induce turbulent air flow, depending on the shape of the wavy fins 208.

Turning to FIG. 20, another example cookware 14 is shown. The cookware 14 can include a square heat maintaining body 86 defining a top cooking surface 82 and a plurality of equally or unequally spaced longitudinal fins 96 extending perpendicularly downward from a bottom surface 100 of the heat maintaining body 86. In at least one of the airflow channels 134 defined between the fins 96, one or more spaced tabs 214 can be arranged in a line or other pattern. The tabs 214 are shown as cylindrical rods, but it is contemplated that the tabs 214 may be any other shape and may also vary in size. The addition of the tabs 214 into the airflow channels 134 can be included to trigger turbulent air flow, and/or increase heat transfer to the heat maintaining body 86. In this way, the tabs 214 can act as turbulence generators. It is also contemplated that other turbulence generators may be used, including for example rods with differently shaped cross sections, air scoops, or bumps, as non-limiting examples.

Turning to FIG. 21, another example cookware 14 is shown. The cookware 14 can include a square heat maintaining body 86 defining a top cooking surface 82 and a plurality of equally or unequally spaced longitudinal fins 96 extending perpendicularly downward from a bottom surface 100 of the heat maintaining body 86. The fins 96 can be spaced from the outermost edges of the sides 154,158, of the heat maintaining body 86. In this way, the cookware 14 may be installed as an elevated shelf within the oven 10. Further, the cookware 14 can include a plurality of angled louvers 222 attached to the distal ends of the fins 96. The louvers 222 are shown as being oriented perpendicular to the direction of the fins 96, but may also be angled with respect to the fins 96. Furthermore, the louvers 222 may angle forward and downward from the distal ends of the fins 96. The louvers 222 can be included to guide air into the airflow channels 134 between the fins 96, which may have otherwise passed beneath the fins 96, to increase heat transfer from the heated air 40 to the fins 96. In this way, the louvers 222 may act as external air scoops that may also induce turbulence into the heated air 40.

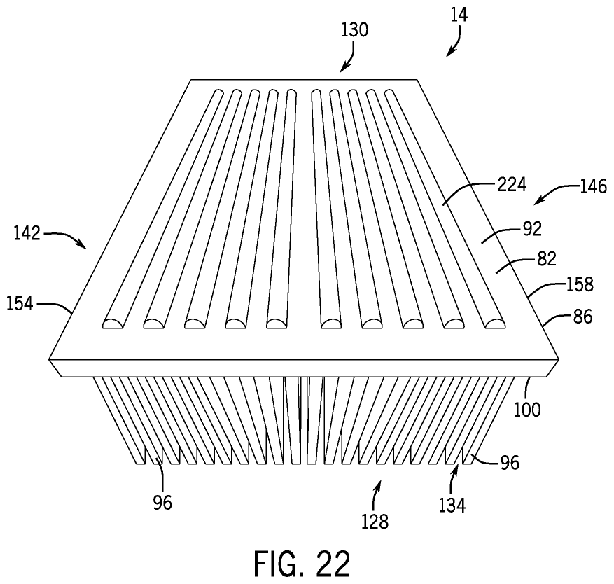

In some embodiments, a cookware 14 may also include additional thermally conductive elements 90 integrated within the heat maintaining body 86. For example, as shown in FIG. 22, a cookware 14 may include a plurality of heat pipes 224. The heat pipes 224 can be a variety of shapes, including straight, curved, and angled. Furthermore, while the heat pipes 224 are shown as being mounted to the cooking surface 82, the heat pipes 82 may also be mounted internally to the heat maintaining body 86 by inserting the heat pipes 224 into one of the side 154, 158 of the heat maintaining body 86. To secure the heat pipes to the heat maintaining body 86, the heat pipes may be glued or soldered or otherwise coupled into place, which may additionally provide for improved heat transfer between the heat pipes 224 and the heat maintaining body 86.

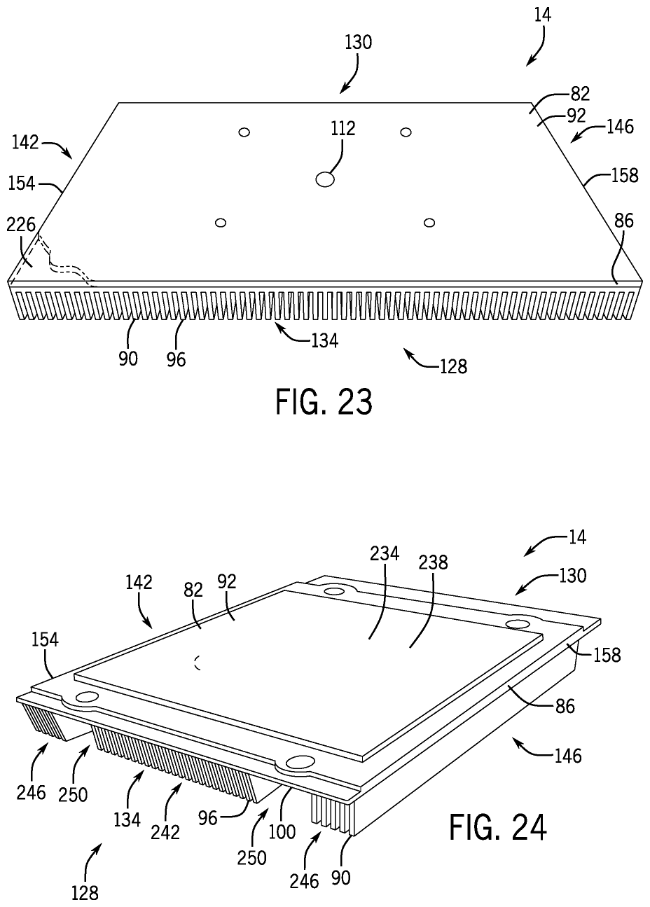

Alternatively, as shown in FIG. 23, another example cookware 14 is shown. The cookware 14 may include a heat maintaining body 86, e.g., a heat plate made of copper, defining a top cooking surface 82. Further, a plurality of fins 96 may extend from a bottom surface 100 of a fin base plate 226. The heat maintaining body 86 can be connected at its bottom surface 100 to a top surface 230 of the fin base plate 226. As heated air 40 passes along the fins 96, heat can be conducted from the fins 96 and into the fin base plate 226, where it can then be conducted into the heat maintaining body 86 to heat the cooking surface 82.

Moreover, as shown in FIG. 24, another example cookware 14 is shown. The cookware 14 can include a rectangular heat maintaining body 86 defining a contoured top cooking surface 82. The top cooking surface 82 can include a central area 234 that may contain a heating element or other heat dispersion element disposed within the heat maintaining body 86. For example, as shown, heat dispersion elements may include a vapor chamber 238 to disperse an even heat across a predefined surface. Furthermore, a plurality of heat conducting fins 96 can extend from a bottom surface 100 of the heat maintaining body 86. The fins 96 can be divided into a wide central group 242 and two thinner peripheral groups 246, which can be divided by a pair of wide air channels 250. Within each of the groups 242, 246 the individual fins 96 can have generally equal spacing defining similarly sized airflow channels 134, or the spacing can be unequal to define unequal sized airflow channels 134.

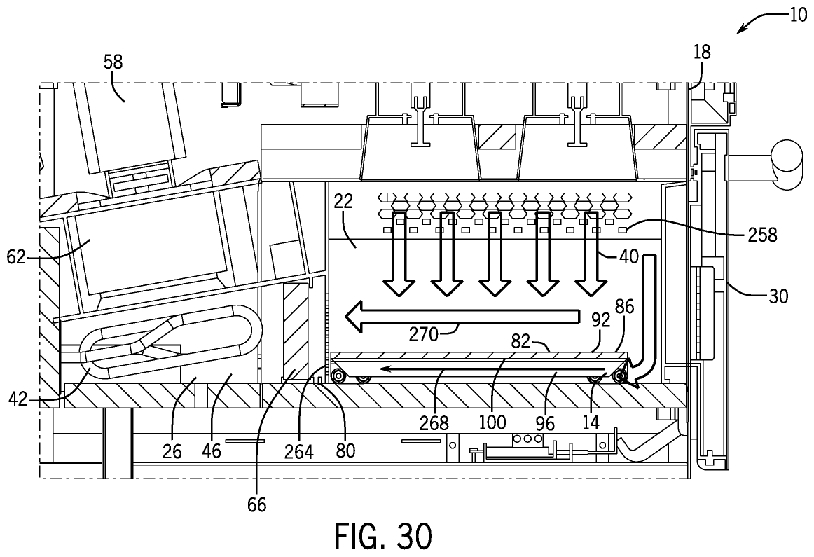

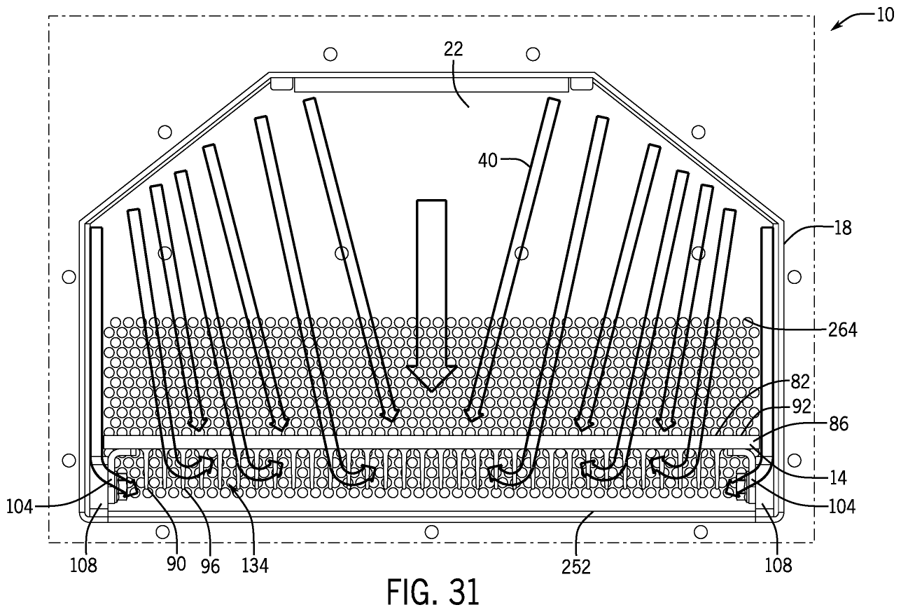

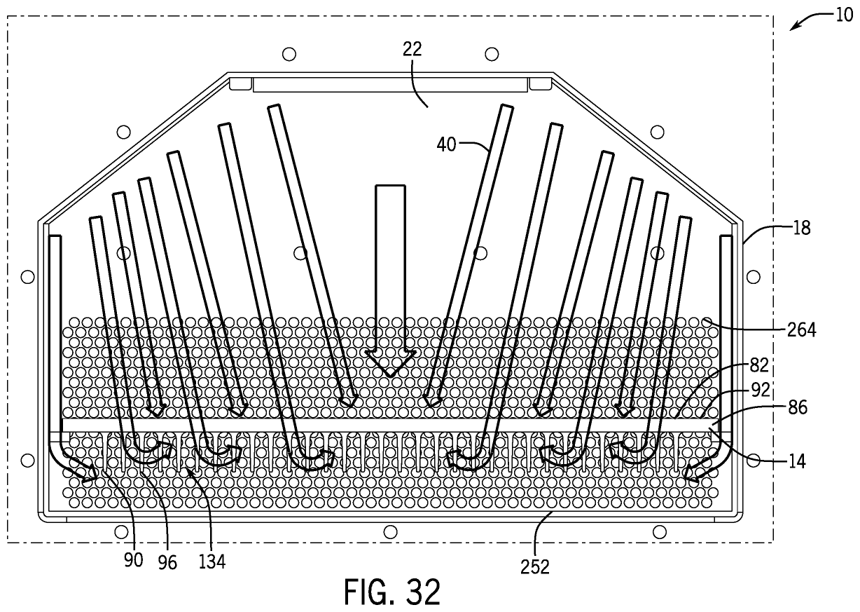

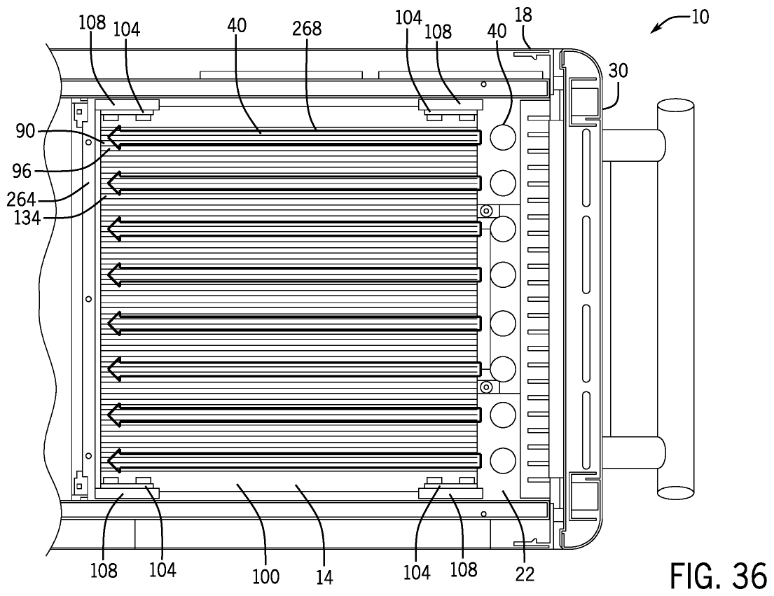

Referring now to FIGS. 30-37, systems and methods of heating food 12 using the oven 10 and the cookware 14 are disclosed. The cookware 14 may be removable from the cooking cavity 22 and/or fixedly mounted within the cooking cavity. For example, as shown in FIG. 31, the cookware 14 may rest on a bottom surface 252 of the oven 10 so that the feet 108 are in contact with the bottom surface 252 of the oven 10. Alternatively, as is shown in FIG. 32, the cookware 14 can be elevated off of the bottom surface 252 and can act as a shelf within the cooking cavity 22 of the oven. For example, the cookware 14 may also be positioned so that the feet 108 rest upon tabs 254 extending from the walls of the interior cavity. In this way, the cookware 14 can be removable from the oven 10 and can be moveable from between the lower position on the bottom 252 of the cooking cavity 22 and the elevated position, and multiple cookwares 14 can be placed in the oven 10 at the same time.

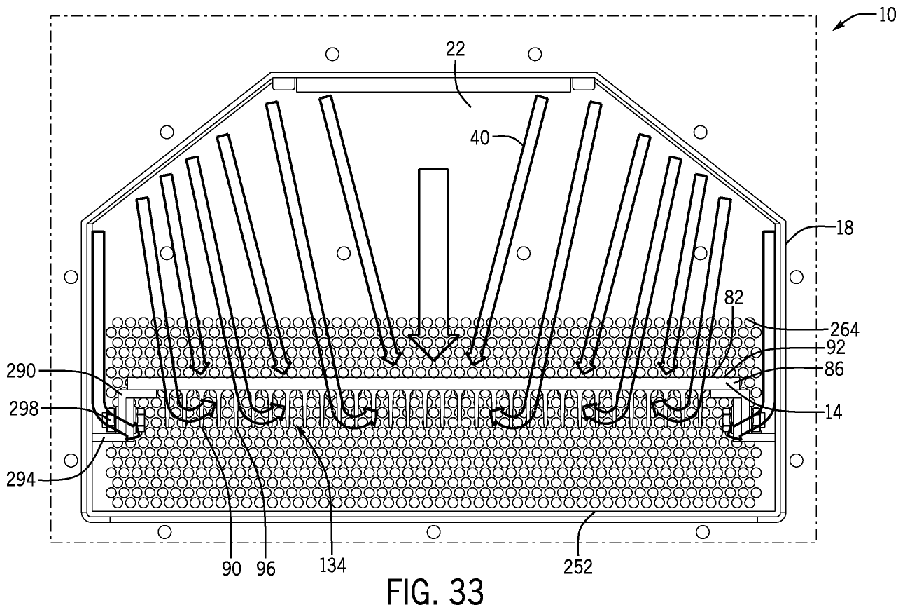

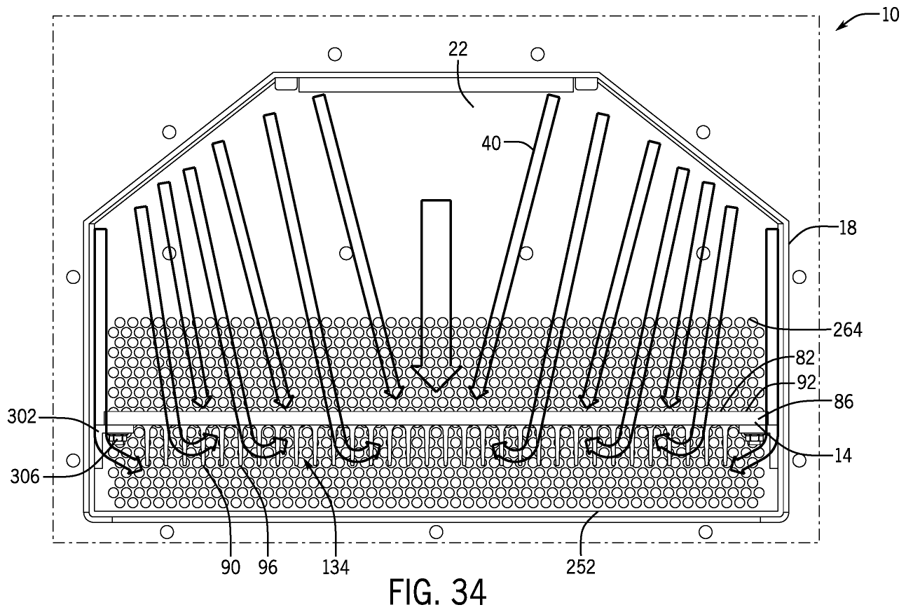

Similarly, as shown in FIG. 33, the cookware 14 may also be stationary such that it is fixedly mounted in a bottom and/or elevated position within the oven 10. In this case, the cookware 14 may include cookware brackets 290 that are configured to connect with oven brackets 294, which may be secured by fasteners 298 or other methods as known in the art. The cookware brackets 290 may couple with the heat maintaining body 86. Alternatively, as is shown in FIG. 34, the cookware 14 may be mounted directly by oven brackets 302, which may be configured to couple with the heat maintaining body 86. That is, the heat maintaining body 86 may be configured to couple directly with one or more oven brackets 302 via fasteners 306 or other methods as known in the art. Similarly, any of the brackets and/or fasteners can be made of electrically insulating material thereby electrically isolating the cookware 14 in the oven 10 from sides of the cooking cavity 22.

Similarly, turning back to FIG. 29, the bottom surface 252 of the cooking cavity 22 may include a base structure 256 extending from the bottom surface 252 and the tabs 254 may extend from the base structure 256.

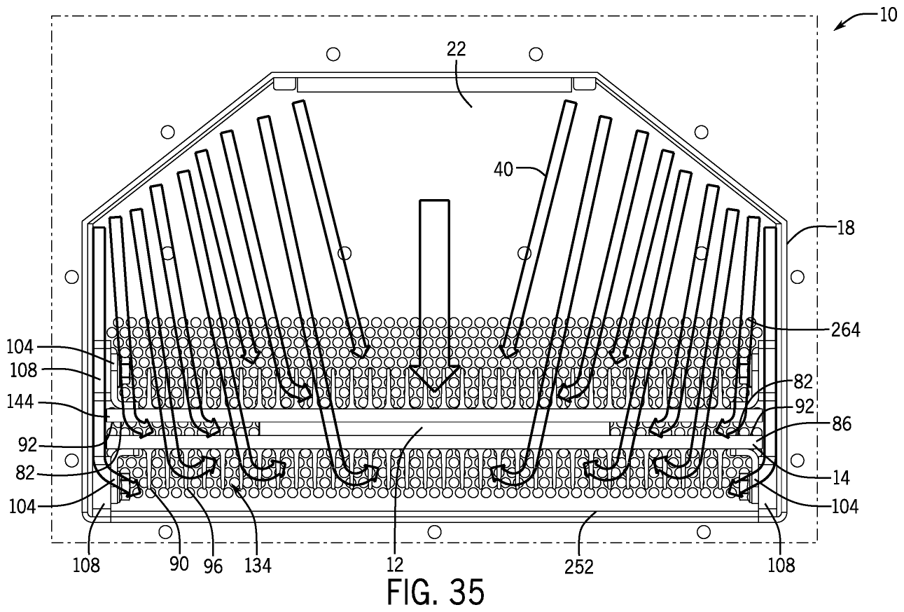

Moreover, it is contemplated that the oven 10 may include more than one cookware 14 disposed within the cooking cavity 22. In the embodiment of FIG. 35, a first cookware 14 and a second cookware 14 are shown and can be arranged to provide multiple shelves and/or cooking areas within the cooking cavity 22, with some of the cookwares 14, 144 being mounted along the bottom surface 252 of the oven 10 and/or some of the cookwares 14, 144 being elevated within the cooking cavity 22 (see e.g., FIGS. 31-34).

Alternatively, as shown in FIG. 35, the second cookware 144 may be inverted (i.e., flipped upside down), so that the heat conducting elements 90 extend upwardly and away from the bottom surface 252 of the oven 10, and/or so that respective cook surfaces of the first and second cookware 14, 144 face one another. The second cookware 144 may be mounted in the cooking cavity 22 of the oven 10 or it may be placed on top of a food item 12 that is positioned on the cook surface 82 of the first cookware 14. In this way, the food item 12 can be browned from the bottom by the first cookware 14 and/or from the top by the second cookware 144. It is also contemplated that in some embodiments, only the second, inverted cookware 144 may be used.

Because the second cookware 144 can be mounted upside down over the first cookware 14, a portion of the heated air 40 may flow downward to directly heat the heat maintaining body 86 of the second cookware 144, and/or along the heat conducting elements 90, for example, fins 96, to conduct heat from the heated air 40 to the heat maintaining body 86. Another portion of the heated air 40 may flow underneath the second cookware 144 and above the first cookware 14 (i.e., between the respective cook surfaces 82 of the first and second cookwares 14, 144) to flow along and directly heat the food item 12. It should be appreciated that this portion of the heated air 40 may also conduct heat directly to each of the heat maintaining bodies 86 via the respective cook surfaces 82. Additionally, yet another portion of the heated air 40 may flow beneath the first cookware 14 and along a plurality of heat conductive elements 90, for example, fins 96, to conduct heat from the heated air 40 to the heat maintaining body 96 of the first cookware 14.

Turning back to FIGS. 30-37, the cookware can 14 comprise a heat maintaining body 86 that retains its high temperature thermal mass through means of conducted heat provided by a plurality of heat conductive elements 90 mounted to or integral with the heat maintaining body 86 to conduct heat energy to the cook surface 82. In some embodiments, the heat conductive elements 90 can be heat conducting fins 96. The fins 96 can protrude outwardly of the heat maintaining body 86 and can be configured to direct the orientation of the heated airflow 40 through the fins 96 in the oven 10, allowing the orientation of the airflow path through the fins 96 to be in the oven's air stream. The cookware 14 can be constructed as a pan or a shelf in a cooking cavity 22.

The oven 10 can further comprise a plurality of nozzles 258 defined in a surface of an air plenum 46, wherein the heated air 40 can enter an oven chamber, e.g., cooking cavity 22 from the air plenum 46 after being expelled through the plurality of nozzles 258. The food 12 can be placed on the cook surface 82 and exposed to the convected heated air 40. At least a portion of the heated air 40 flowing through the nozzles 258 may contact and directly heat the food 12. The heated air within the cooking cavity 22 can be returned to a heater plenum 26 via an intake opening 264, located at least partially below the cookware 14, and can be positioned opposite the door 30 of the oven 10.

Thus, at least a portion of the heated air 40 can be forced to flow along path 268, such that the heated air 40 flows underneath the cookware 14 and through the fins 96 of the cookware 14, and back to the heater plenum 26. Additional heated air 40 can return to the heater plenum 26 via the intake opening 264 above the cookware 14 following path 270. When the heated air 40 flows through the fins 96 following path 268, additional heat energy can be absorbed by the fins 96 and then can be conducted though the fins and the heat maintaining body 86 to the cook surface 82. The plurality of fins 96 can be placed in a pattern on the bottom surface 100 of the heat maintaining body 86 so as to provide a desired heating pattern for the food 12 placed on the cookware 14. Thus the heated air 40 flowing along path 268 may indirectly heat the food 12 while the heated air 40 travelling along path 270 may directly heat the food 12.

The heat energy conducted by the fins 96 is added to the heat energy of the heat maintaining body 86, and can cause greater even heating of the food 12 that is near or in contact with the cook surface 82 of the cookware 14, thereby creating desired appearance of food 12, such as even browning of the surface of the food 12. Furthermore, the additional heat conducted to the food item 12 can allow the heat maintaining body 86 to maintain a temperature close to a temperature set point of the oven 10, even after repeated cold food loads are placed on the cook surface 82 of the cookware 14, which can lead to reduced cooking times.

For the avoidance of doubt, aspects of the present disclosure described with respect to the systems are applicable to the methods, and aspects described with respect to the methods are applicable to the systems.

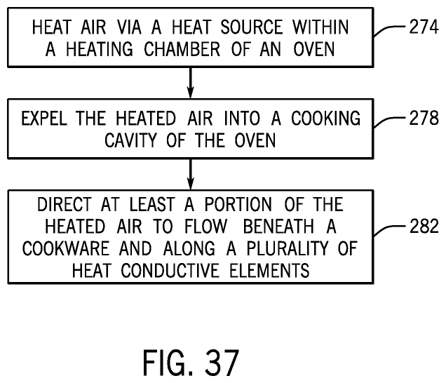

FIG. 37 illustrates an embodiment of a method for heating food 12 including the use of the cookware 14 according to the present disclosure. The method shown in FIG. 34 may be used in conjunction with any of the systems or devices shown in the above Figures, among others. In various embodiments, some of the method elements shown may be performed concurrently, in a different order than shown, or may be omitted. Additional method elements may also be performed as desired.

The method for heating food 12 can include a plurality of steps. A first step 274 may include heating air 40 via a heating element 42 disposed within a heating chamber 26 of an oven 10. A further step 278 can include expelling the heated air 40 into a cooking cavity 22 of the oven 10. In some cases, a fan or blower wheel 62 that is powered by a motor 58 may be used to expel the heated air 40. Furthermore, expelling the heated air 22 may include expelling the heated air 40 into the cooking cavity 22 via nozzles 258 in one or more air plenums. A further step 282 can include directing at least a portion of the heated air 40 beneath a cookware 14 that is positioned within the cooking cavity 22. The heated air 40 can travel along a plurality of heat conductive elements 90, for example, fins 96 that can extend from a bottom surface 100 of a heat maintaining body 86, opposite a cooking surface 82 of the heat maintaining body 86. When the heated air 40 travels along the heat conductive elements 90, heat from the heated air 40 is conducted through the heat conductive elements 90 to heat the cookware 14. More specifically, the heat is conducted through the heat conductive elements 90 and into the heat maintaining body 86 to heat the cooking surface 86. In some cases, a second portion of heated air 40 may be directed at the cook surface 82 to directly heat a food item 12 that is positioned on the cooking surface 82.

The present disclosure describes embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The described features, structures, or characteristics of the embodiments may be combined in any suitable manner in one or more embodiments. In the description, numerous specific details are recited to provide a thorough understanding of embodiments of the disclosure. One skilled in the relevant art will recognize, however, that the embodiments may be practiced without one or more of the specific details, or with other methods, components, materials, and so forth. In other instances, well-known structures, materials, or operations are not shown or described in detail to avoid obscuring aspects of the disclosure.

Although the above discussion discloses various exemplary embodiments of the disclosure, it should be apparent that those skilled in the art can make various modifications that will achieve some of the advantages of the disclosure without departing from the true scope of the disclosure.

What is claimed is:

1. An oven comprising:
a housing;
a heating chamber positioned within the housing;
a heat source to provide convective heated air to the heating chamber; and
a cookware within the heating chamber, the cookware comprising a heat maintaining body defining a cook surface and a plurality of heat conductive elements extending from the heat maintaining body in a direction away from the cook surface;
wherein the heat conductive elements are configured to conduct heat from the heated air to the heat maintaining body as the heated air flows past the heat conductive elements, and
wherein the cook surface is heated directly from above by the convective heated air entering the heating chamber and indirectly from below by the heat conductive elements conducting heat from the convective heated air to the cook surface.

2. The oven of claim 1, wherein the plurality of heat conductive elements is a plurality of fins extending in a direction of an airflow path of the convective heated air.

3. The oven of claim 1, wherein the plurality of heat conductive elements is a plurality of fins tangent, angled, or perpendicular to a direction of an airflow path to create directionality or turbulence in the convective heated air.

4. The oven of claim 1, wherein the cook surface of the heat maintaining body includes an integrated thermal generative device that is mounted any of internally, below, or under a bottom cavity of the oven or cookware, the thermal generative device including at least one of a calrod heating element, a ribbon heating element, a mica heating element, and a silicone heating element.

5. The oven of claim 4, wherein the cookware includes a removable cookware body that has a power connection to engage with a respective oven power connection when the cookware is inserted into the oven.

6. The oven of claim 1, wherein the cookware further includes a plurality of legs having a fixed or variable height to lift the cookware off the bottom of the heating chamber.

7. The oven of claim 6, wherein each leg includes at least one foot to electrically insulate the cookware from the heating chamber.

8. The oven of claim 1, wherein the cookware is configured to be at least one of removable from the heating chamber of the oven and fixedly mounted within the heating chamber of the oven.

9. The oven of claim 1, wherein the heat conductive elements are arranged so that the cookware has a first cook profile when placed in the oven in a first orientation and a second cook profile when placed in the oven in a second orientation.

10. The oven of claim 1 further including at least a second cookware positioned above the cookware.

11. The oven of claim 10, wherein the second cookware is inverted so that the cook surface of the cookware faces a cook surface of the second cookware.

12. A cookware for use in an oven, the cookware comprising:
a heat maintaining body defining a cook surface;
a plurality of heat conductive elements including a plurality of fins that extend from the heat maintaining body in a direction away from the cook surface; and
a plurality of legs coupled to the fins, the legs extending away from the heat maintaining body in a direction opposite the cook surface,
wherein the heat conductive elements are configured to conduct heat from a convective air flow to the heat maintaining body.

13. The cookware of claim 12, wherein at least a portion of the plurality of fins are oriented in a direction of the convective air flow.

14. The cookware of claim 12, wherein at least a portion of the plurality of fins are oriented tangent, angled, or perpendicular a direction of an airflow path to create directionality or turbulence in the convective air flow.

15. The cookware of claim 12, wherein at least a portion of the plurality of fins have surface deformations including at least one of recesses, bumps, ridges and sub-fins, to create additional surface area, directionality, or turbulence in the convective air flow.

16. The cookware of claim 12, wherein the cookware defines an interior channel and the plurality of fins are disposed within the interior channel.

17. The cookware of claim 12, wherein the plurality of fins includes any of rectangular, square, and rounded fins that are disposed in an offset or staggered relationship.

18. The cookware of claim 12, wherein the plurality of fins create a weaved or waved airflow path that increases turbulence in the convective air flow.

19. The cookware of claim 12, wherein the plurality of heat conductive elements are made of a first material and the heat maintaining body is made of a second material.

20. The cookware of claim 12, wherein the plurality of heat conductive elements includes a plurality of turbulence generators to increase turbulence in the convective air flow, the turbulence generators including at least one of a plurality of rods and a plurality of air scoops.

21. The cookware of claim 12, wherein the cook surface of the heat maintaining body includes an integrated thermally conductive feature to increase heat dispersion, the thermally conductive feature including at least one of a heat pipe and a heat plate.

22. The cookware of claim 12, wherein the plurality of legs are at least one of disposed between two or more of the plurality of fins, and connected on the outside of the plurality of fins.

23. The cookware of claim 12, wherein each of the plurality of legs are formed from a non-conductive material.

24. The cookware of claim 12, where in the plurality of heat conductive elements may be permanently or removably coupled to the heat maintaining body of the cookware.

25. A method for heating food comprising:
heating air via a heat source within a heating chamber of an oven;
expelling the heated air into a cooking cavity of the oven toward a cook surface of a cookware, the cook surface being a top surface of a heat maintaining body; and
directing at least a portion of the heated air to flow beneath the cookware and along a plurality of heat conductive elements extending from at least one of a bottom surface and an enclosed surface of the heat maintaining body, the heat conductive elements extending in a direction away from the cook surface,
wherein heat from the heated air is conducted through the heat conductive elements to the heat maintaining body to heat the cook surface from the bottom surface of the heat maintaining body.

26. The method of claim 25, wherein the step of expelling the heated air into the cooking cavity includes blowing the heated air from an air plenum using a fan.
